(19) United States
(12) Patent Application Publication
(10) Pub. No.: US 2016/0301280 A1
(43) Pub. Date: Oct. 13, 2016

(54) Wheel Hub Drive

(71) Applicant: SIEMENS AKTIENGESELLSCHAFT, München (DE)

(72) Inventors: Gunter FREITAG, Muenchen (DE); Klaus SCHLEICHER, Nuernberg (DE); Harald MÜLLER, Gerhardshofen (DE)

(73) Assignee: Siemens Aktiengesellschaft, Muenchen (DE)

(21) Appl. No.: 15/033,822

(22) PCT Filed: Oct. 23, 2014
(86) PCT No.: PCT/EP2014/072715

§ 371 Date: May 2, 2016

(30) Foreign Application Priority Data
Oct. 31, 2013 (DE) 102013222229.7

(51) Int. Cl. H02K 5/167

(52) U.S. Cl. CPC H02K 5/167

(57) ABSTRACT

A wheel hub drive has an electric motor that includes a stator and a sleeve-shaped rotor, wherein a ring structure that is coaxial to the rotor is arranged on at least one inner mounting surface that delimits the rotor in the axial direction, and wherein the ring structure exhibits a smaller coefficient of sliding friction than the inner mounting surface that delimits the rotor.

### CROSS-REFERENCE TO RELATED APPLICATIONS

This application is a U.S. National Stage Application of International Application No. PCT/EP2014/072715 filed Oct. 23, 2014, which designates the United States of America, and claims priority to DE Application No. 10 2013 222 229.7 filed Oct. 31, 2013, the contents of which are hereby incorporated by reference in their entirety.

### TECHNICAL FIELD

The invention relates to a wheel hub drive, e.g., for a wheel of a vehicle.

### BACKGROUND

A wheel hub drive or a wheel hub motor is a motor that is fitted directly in a wheel of a vehicle. According to the prior art, electric motors are usually used for a wheel hub drive. A major advantage of electric wheel hub drives is that they do not need the classic drive train.

Wheel hub motors are typically only mounted on one side. As a result, the mechanical system of a wheel hub motor only has a low tilting stability. The low tilting stability results in greater relative movements of the rotating and stationary components in relation to one another under loading. The relative movements in turn lead to contact between the rotating components and stationary components and can consequently result in damage. Such instances of damaging contact between the components may occur in particular in the case of lateral accelerations, for example when cornering and/or when the roadway produces resonant excitations. In addition, the effects mentioned are exacerbated in the case of vehicles with an intricate suspension geometry.

According to the prior art, it is attempted to avoid the damaging instances of contact between the components by means of large axial air gaps. However, this results in the direct disadvantage that the space requirement is increased due to the unnecessary air gaps and due to the increased distances between the components.

In order to overcome the disadvantages of known wheel hub drives, the prior art therefore proposes specially developed wheel hub drives, which in particular have increased stiffness and/or use larger bearings and/or different materials.

What is disadvantageous about this is that the known concepts for wheel hub drives can only be adopted with great expenditure and great structural modifications. In particular, known low-cost bearings do not have sufficient tilting stability to avoid contact between the rotating components during loading.

### SUMMARY

One embodiment provides a wheel hub drive comprising an electric motor, the electric motor comprising a stator and a sleeve-shaped rotor, a ring structure aligned coaxially with the rotor being arranged on at least one inner attachment face delimiting the rotor in the axial direction, wherein the ring structure has a smaller coefficient of sliding friction than the one delimiting inner attachment face of the rotor.

In one embodiment, the ring structure is connected to the rotor in an interlocking and/or friction-locking manner.

In one embodiment, the ring structure is connected to the rotor by means of screw connections, at least a partial region of the ring structure having an axial overhang with respect to the screw connections.

In one embodiment, the ring structure is connected to the rotor by means of clip connections.

In one embodiment, the ring structure comprises the material Teflon.

In one embodiment, the coefficient of sliding friction of the ring structure with respect to a housing is less than or equal to 0.04.

In one embodiment, an inner diameter and an outer diameter of the ring structure differ by an amount of at most 10 mm.

In one embodiment, the ring structure has a coating, a coefficient of sliding friction of the coating being smaller than the coefficient of sliding friction of the ring structure.

### BRIEF DESCRIPTION OF THE DRAWINGS

Example embodiments and aspects of the invention are described below with reference to the drawings, in which:

FIG. 1 shows contact-free operation of a wheel hub drive;

FIG. 2 illustrates contact between components under loading; and

FIG. 3 shows a schematic representation of a ring structure.

### DETAILED DESCRIPTION

Embodiments of the present invention provide a wheel hub drive that reduces the damaging nature of instances of contact.

In some embodiments, the wheel hub drive comprises an electric motor, the electric motor comprising a stator and a sleeve-shaped rotor. In this case, a ring structure aligned coaxially with the rotor is arranged on at least one inner attachment face delimiting the rotor in the axial direction. The ring structure may have a smaller coefficient of sliding friction than the one delimiting inner attachment face of the rotor.

The relative terms axial and radial always relate to an axis of rotation of the rotor.

The wheel hub drive may provide the advantage that, when there is contact of the rotor with another component of the wheel hub drive, the damaging nature of the contact is greatly reduced as a result of the smaller coefficient of sliding friction of the ring structure. The coefficient of sliding friction of the ring structure may be smaller, e.g., much smaller, than the delimiting inner attachment face of the rotor, so that, when there is contact of the rotor with other components under loading, no significant damage is produced on the rotor and/or on the component coming into contact. The rotating sliding layer that is formed by the ring structure with a smaller coefficient of sliding friction allows the mechanical structure of for example the housing and the mounting to be designed with a reasonable relationship between mass and volume with respect to performance. The necessary stiffness and/or strength of the rotor is also not influenced by the ring structure. Consequently, contact between the components is not absolutely prevented, but instead the damaging nature of the contact between the components is reduced. This gives rise to the advantage that in particular smaller bearings or standard bearings with customary materials can be used for the wheel hub drive. There is no need for special components or major structural modifications, resulting in a clear cost advantage. Moreover, the overall space requirement for the wheel hub drive is advantageously reduced. Instances of chipping and/or scratching on the rotor are advantageously avoided by the ring structure that is attached to the rotor and forms part of the rotor.

In one embodiment, the ring structure is connected to the rotor in an interlocking and/or friction-locking manner.

This may ensure that, in the event of contact occurring during loading, the ring structure continues to be firmly connected to the rotor. As a result, abrasive removal and/or detachment of the ring structure from the rotor can be advantageously avoided. The interlocking connection has the effect of ensuring that the force that occurs in the event of contact between the components during loading is distributed uniformly over a surface area that is as large as possible.

In one embodiment, the ring structure is connected to the rotor by means of screw connections, at least a partial region of the ring structure having an axial overhang with respect to the screw connections.

The screw connections advantageously have the effect of creating a friction-locking connection between the ring structure and the rotor, which withstands the loads during contact of the rotor or the ring structure with another component. In this case, the ring structure has an axial overhang with respect to the screw connections, so that contact between stationary components and the screw connections is avoided. As a result, instances of damage to the rotor and other components are reduced. For example, countersunk grooves may be incorporated in the ring structure, so that the axial overhang of the ring structure is made possible by means of countersunk screws.

In one embodiment, the ring structure is connected to the rotor by means of clip connections.

As a result, assembly of the wheel hub drive is advantageously facilitated.

In a further embodiments, the ring structure comprises the material Teflon.

Teflon has an extremely small coefficient of sliding friction, so that instances of damage that occur in the event of contact between the sliding surfaces (ring structure) and another component can be significantly reduced.

In one embodiment, the coefficient of sliding friction of the ring structure with respect to a housing is less than or equal to 0.04.

The small coefficient of sliding friction of the ring structure advantageously has the effect that instances of damage to the ring structure and/or to the housing when there is contact under loading are avoided. In this case, the housing expediently encloses the rotor and/or the stator.

According to a further embodiment, an inner diameter and an outer diameter of the ring structure differ by an amount of at most 10 mm.

The ring structure is thereby advantageously formed in a disk-like manner as a thin ring, so that the space requirement resulting from the additional ring structure can be kept as little as possible.

In one embodiment, the ring structure has a coating, a coefficient of sliding friction of the coating being smaller, in particular much smaller, than the coefficient of sliding friction of the ring structure.

As a result, the sliding friction properties of the ring structure with respect to the delimiting inner attachment faces of the rotor are advantageously additionally improved. For example, an additional coating with commonly used plastics, in particular with Teflon, is of advantage.

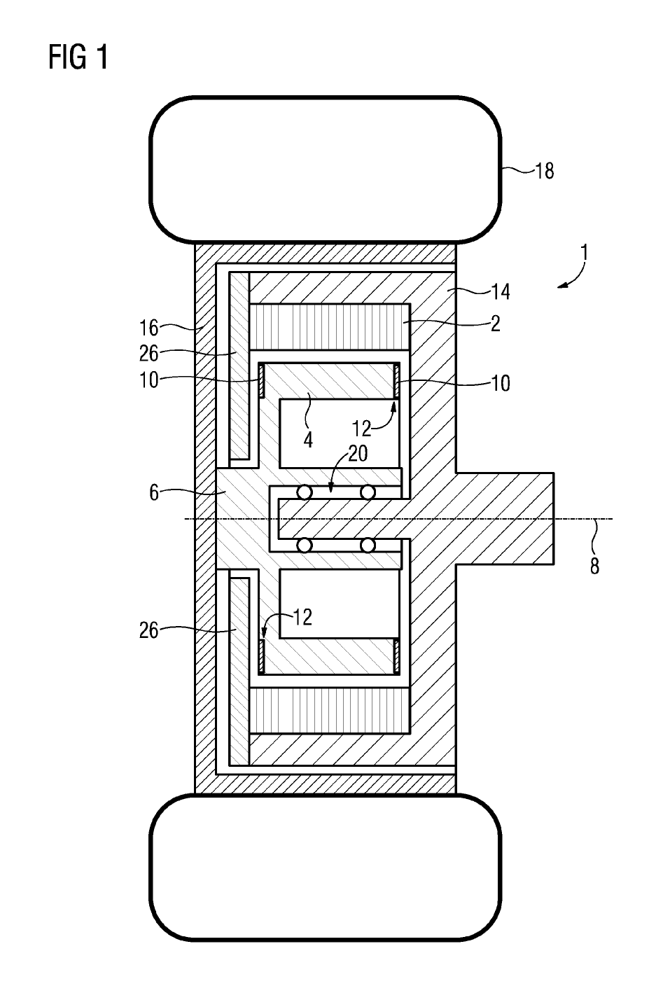

FIG. 1 shows a section of a wheel hub drive 1 along an axis of rotation 8 (axial direction), the wheel hub drive 1 comprising an electric motor with a stator 2 and a rotor 4. In this case, the stator 2 and the rotor 4 are arranged within a housing 14, which in turn is located within a rim 16. For purposes of illustration, only one wheel with a tire 18 is represented. Generally, all of the wheels of a vehicle (not represented) may be provided with the wheel hub drive 1 that is represented in FIG. 1. The tire 18 rotates about the axis of rotation 8. The rotor 4 is connected in a torque-locking manner to a hole circle 6 of the rim 16, the hole circle 6 and the rim 16 being arranged coaxially in relation to the axis of rotation 8.

The hole circle 6 is in turn in torque-locking connection with the rim 16 by way of rim bolts that are not shown, the rim 16 driving the tire 18. To avoid dirt and/or water, the housing 14 additionally has at least one housing cover 26. The rotor 4 and the hole circle 6 are supported by a rotary bearing 20.

A ring structure 10 is respectively arranged on axial inner attachment faces 12 of the rotor 4. In order to save installation space, it is of advantage to keep air gaps, for example between the rotor 4 and the stator 2 and/or between the rotor 4 and the housing 14, as small as possible. As a result, however, contact between components, for example the rotor 4 and the housing 14, during loading can only be avoided with difficulty. To reduce the damaging nature of such contact, according to the invention the ring structure 10 is provided.

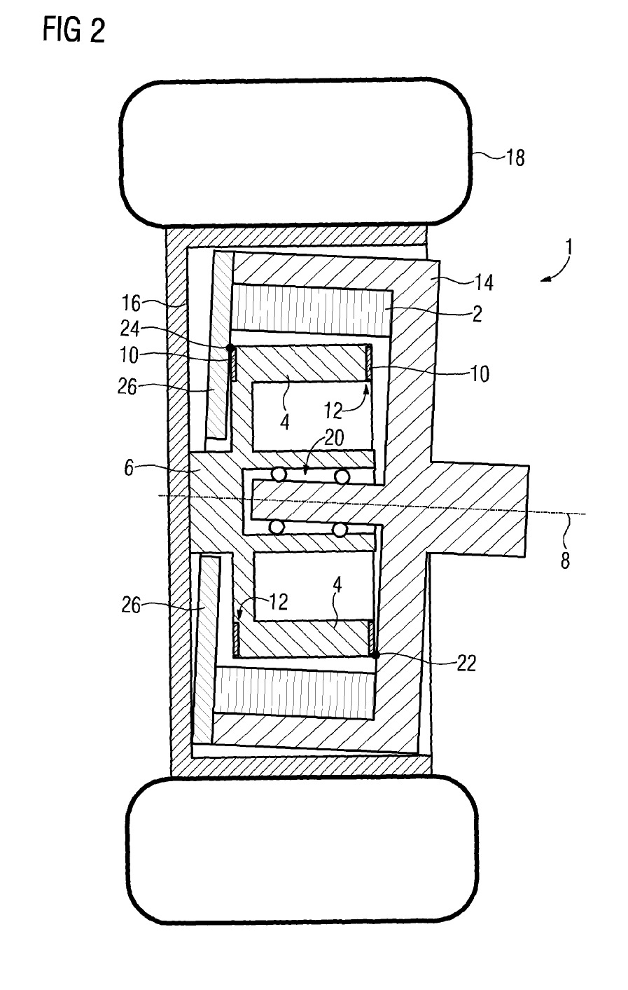

FIG. 2 shows a contact 22, 24 of the ring structure 10 with the housing 14 or the housing cover 26. If a tilting of the rotor 4 occurs under loading of the wheel hub drive, for example due to vibrations, the ring structure 10 and housing 14 or the housing cover 26 come into contact at the contact points 22, 24. On account of the particularly good sliding properties of the ring structure 10, the damage at the contact points 22, 24 is kept as little as possible. In particular, the rotor 4 is not in direct contact with the housing 14 or the housing cover 26 during tilting loading. It is mainly the ring structure 10 that is subjected to the frictional forces. However, in some embodiments the ring structure 10 has a smaller, in particular much smaller, coefficient of sliding friction with respect to the rotor 4. As a result, instances of damage to the rotor 4 or other components during tilting loading are advantageously avoided. The ring structure 10 consequently forms an emergency running device.

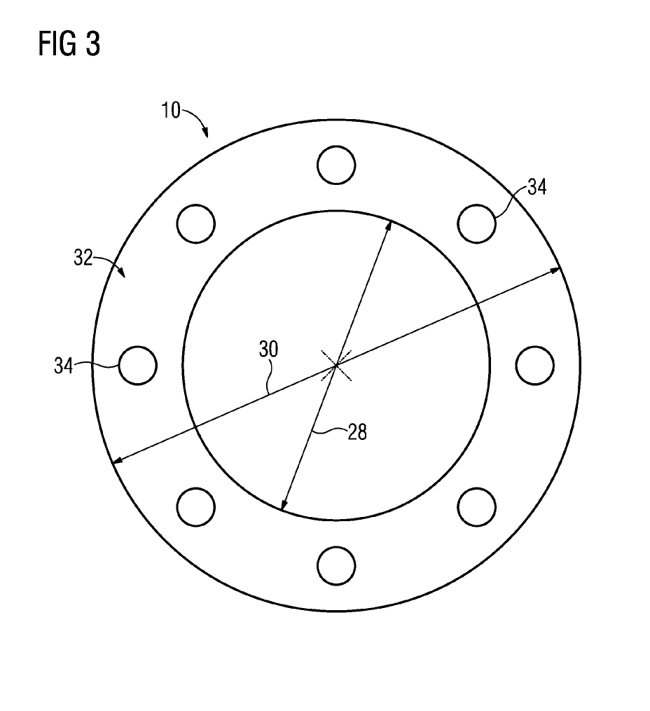

FIG. 3 shows a schematic representation of the ring structure 10. In this case, the ring structure 10 has an inner diameter 28 and an outer diameter 30. The difference between the inner diameter 28 and the outer diameter 30 is advantageously of an amount less than or equal to 10 mm.

The ring structure 10, formed as a thin disk 10, advantageously has a plurality of countersunk grooves 34, which are distributed regularly over a surface 32 of the ring structure 10. The countersunk grooves 34 allow an interlocking and/or friction-locking attachment of the ring structure 10 to the rotor 4 by means of countersunk screws. In addition, it is envisaged to coat the surface 32 of the ring structure 10 with a material that has a smaller coefficient of sliding friction than the ring structure 10. The ring structure 10 can advantageously be produced at low cost by the injection-molding process, involving little technical expenditure.

What is claimed is:

1. A wheel hub drive comprising:
an electric motor, comprising a stator and a sleeve-shaped rotor,
wherein a ring structure aligned coaxially with the rotor is arranged on at least one inner attachment face delimiting the rotor in an axial direction, and
wherein the ring structure has a smaller coefficient of sliding friction than the at least one delimiting inner attachment face of the rotor.

2. The wheel hub drive of claim 1, wherein the ring structure is connected to the rotor in at least one of an interlocking manner or a friction-locking manner.

3. The wheel hub drive of claim 2, wherein the ring structure is connected to the rotor by screw connections, wherein at least a partial region of the ring structure has an axial overhang with respect to the screw connections.

4. The wheel hub drive of claim 2, wherein the ring structure is connected to the rotor by clip connections.

5. The wheel hub drive of claim 1, wherein the ring structure comprises the material Teflon.

6. The wheel hub drive of claim 1, wherein the coefficient of sliding friction of the ring structure with respect to a housing is less than or equal to 0.04.

7. The wheel hub drive of claim 1, wherein an inner diameter and an outer diameter of the ring structure differ by 10 mm or less.

8. The wheel hub drive of claim 1, wherein the ring structure has a coating having a coefficient of sliding friction that is smaller than the coefficient of sliding friction of the ring structure.

9. A vehicle, comprising:
a plurality of wheels,
a wheel hub drive associated with each wheel, each wheel hub drive comprising:
an electric motor comprising a stator and a sleeve-shaped rotor,
wherein a ring structure aligned coaxially with the rotor is arranged on at least one inner attachment face delimiting the rotor in an axial direction, and
wherein the ring structure has a smaller coefficient of sliding friction than the at least one delimiting inner attachment face of the rotor.

10. The vehicle of claim 9, wherein for each wheel hub drive, the ring structure is connected to the rotor in at least one of an interlocking manner or a friction-locking manner.

11. The vehicle of claim 10, wherein for each wheel hub drive, the ring structure is connected to the rotor by screw connections, wherein at least a partial region of the ring structure has an axial overhang with respect to the screw connections.

12. The vehicle of claim 10, wherein for each wheel hub drive, the ring structure is connected to the rotor by clip connections.

13. The vehicle of claim 9, wherein for each wheel hub drive, the ring structure comprises the material Teflon.

14. The vehicle of claim 9, wherein for each wheel hub drive, the coefficient of sliding friction of the ring structure with respect to a housing is less than or equal to 0.04.

15. The vehicle of claim 9, wherein for each wheel hub drive, an inner diameter and an outer diameter of the ring structure differ by 10 mm or less.

16. The vehicle of claim 9, wherein for each wheel hub drive, the ring structure has a coating having a coefficient of sliding friction that is smaller than the coefficient of sliding friction of the ring structure.
